(19) United States
(12) Patent Application Publication
(10) Pub. No.: US 2022/0164357 A1
(43) Pub. Date: May 26, 2022

(54) METHODS AND SYSTEMS OF DYNAMICALLY MANAGING CONTENT DELIVERY OF SENSOR DATA FROM NETWORK DEVICES

(71) Applicant: SIGHTHOUND, INC., Winter Park, FL (US)

(72) Inventors: Eric Paver SIMON, Denver, CO (US); Kamiar Keating COFFEY, Superior, CO (US); Nathaniel Rivers NEWMAN, Aurora, CO (US); Darren ODOM, Longmont, CO (US)

(21) Appl. No.: 17/534,572

(22) Filed: Nov. 24, 2021

Related U.S. Application Data
(60) Provisional application No. 63/118,304, filed on Nov. 25, 2020.
(60) Provisional application No. 63/118,309, filed on Nov. 25, 2020.
(60) Provisional application No. 63/118,310, filed on Nov. 25, 2020.

(51) Int. Cl. G06F 16/2455

(52) U.S. Cl. CPC G06F 16/24556

(57) ABSTRACT

The present application is at least directed to a method of dynamically managing content delivery of sensor data to a third party. A step of the method may include receiving, via plural smart devices each including a trained machine learning algorithm, data of an object detected in an environment and filtered to remove an attribute of the detected object. Another step of the method may include aggregating the filtered data with the removed attribute received from the plural devices. Yet another step of the method may include obtaining a credential of a third party requesting the aggregated data of the object. Yet even another step of the method may include determining, via another trained machine learning algorithm, an additional filter of the aggregated data is required in view of the credential of the third party. A further step of the method may include transmitting, to the third party, the additionally filtered data in view of the credential. Yet even a further step of the method may include dynamically displaying, via a graphical user interface, a real-time status of the third party obtaining the additionally filtered data.

### CROSS REFERENCE TO RELATED APPLICATIONS

This application claims the benefit of priority of U.S. Provisional application No. 63/118,304 filed Nov. 25, 2020, entitled “Method and System of Filtering Sensor Data in a Network,” U.S. Provisional application No. 63/118,309 filed Nov. 25, 2020, entitled “Method and System of Aggregating Sensor Data and Filtering for Transmission to a Third Party,” and U.S. Provisional application No. 63/118,310 filed Nov. 25, 2020, entitled “Method and System of Securing Access to Sensor Data,” the contents of which are incorporated by reference in their entirety.

### FIELD

This application is generally related to methods and systems of selectively managing content delivery of sensed data originating from Internet of Things (IoT) or edge devices operating in a network. Sensed data from IoT devices may arrive in a filtered state and/or be additionally filtered to meet security protocols prior to transmitting to one or more third parties.

### BACKGROUND

IoT has helped aggregate large volumes of data for assessment and downstream monetization. Specifically, various types of sensors may be associated with cameras to help capture scenes in an environment. These sensors may collect certain types of data from scenes in the environment, such as for example, position, occupancy, counts, objects, light, and the like.

Certain aspects of collected data may inherently raise privacy concerns. Meanwhile, other aspects of collected data may pose little or no threat. For example, collecting data on the number or frequency of individuals passing through a select geographic location may not overtly raise concerns. Meanwhile, for a protected class of individuals such as minors may necessitate additional security measures.

Mapping trends from vast amounts of raw or filtered data may present its owns challenges. And perhaps even more challenging may be the process of managing security protocols and selectively disseminating mapped data to one or more downstream third parties.

What is desired in the art is an architecture that minimizes risk associated with collected sensor data ultimately transmitted to third parties. What is also desired is an architecture that manages and controls security and privacy profiles at the device and network levels.

What is further desired is a cloud architecture that may collect raw or filtered sensor data from one or more local networks, and selectively transmit aspects of the collected data in view of real-time modifications to security measures based on the data and the third party.

### SUMMARY

The foregoing needs are met, to a great extent, by the disclosed system and method described herein.

One aspect of the application is directed to a method of dynamically managing content delivery of sensor data to a third party. A step of the method may include receiving, via plural smart devices each including a trained machine learning algorithm, data of an object detected in an environment and filtered to remove an attribute of the detected object. Another step of the method may include aggregating the filtered data with the removed attribute received from the plural devices. Yet another step of the method may include obtaining a credential of a third party requesting the aggregated data of the object. Yet even another step of the method may include determining, via another trained machine learning algorithm, an additional filter of the aggregated data is required in view of the credential of the third party. A further step of the method may include transmitting, to the third party, the additionally filtered data in view of the credential. Yet even a further step of the method may include dynamically displaying, via a graphical user interface (GUI), a real-time status of the third party obtaining the additionally filtered data.

Another aspect of the application is directed to a method of dynamically managing content delivery of sensor data to a third party. A step of the method may include receiving, via a first and a second local network, each including a smart device with a trained machine learning algorithm operating thereon, data of an object detected in an environment. The smart device of the first local network may be configured to remove an attribute of the detected object. Another step of the method may include aggregating, at a cloud host, the received data from the first and second local networks, obtaining a credential of a third party requesting the aggregated data of the object. Yet another step of the method may include determining, via a trained machine learning algorithm operating at the cloud host, a privacy filter of the aggregated data is required based on the credential of the third party. A further step of the method may include transmitting, to the third party, the privacy filtered data in view of the credential.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

### BRIEF DESCRIPTION OF THE DRAWINGS

In order to facilitate a fuller understanding of the invention, reference is now made to the accompanying drawings, in which like elements are referenced with like numerals. These drawings should not be construed as limiting the invention and intended only to be illustrative.

FIG. 1A illustrates a system diagram of an exemplary networked edge device.

FIG. 1B illustrates a block diagram of exemplary computing peripherals of the edge device.

FIG. 1C illustrates a system configured to obtain training data to train a learning model for selectively filtering data according to an aspect of the application.

FIG. 2A illustrates an exemplary operating environment where filtered data is collected from IoT devices and subsequently filtered one or more times by a local network and/or a cloud host in view of security or privacy settings and/or credentials of third party customers according to an aspect of the application.

FIG. 2B illustrates another exemplary operating environment where data is collected from IoT devices located on plural local networks and shared with a common cloud that performs filtering in view of security or privacy setting and/or credentials of third party customers according to an aspect of the application.

FIG. 3 illustrates an exemplary GUI of the cloud host managing filters of IoT devices and local networks for selectively sharing data with third party customers in view of credentials according to an aspect of the application.

FIG. 4 illustrates an exemplary flowchart of an aspect of the application directed to a method of aggregating sensor data and filtering for transmission to a third party.

FIG. 5A illustrates an exemplary flowchart of an architecture for managing data flow via machine learning according to an aspect of the application.

FIG. 5B illustrates another exemplary flowchart of an architecture for managing data flow via machine learning according to an aspect of the application.

### DETAILED DESCRIPTION

In this respect, before explaining at least one embodiment of the invention in detail, it is to be understood that the invention is not limited in its application to the details of construction and to the arrangements of the components set forth in the following description or illustrated in the drawings. The invention is capable of embodiments or embodiments in addition to those described and of being practiced and carried out in various ways. Also, it is to be understood that the phraseology and terminology employed herein, as well as the abstract, are for the purpose of description and should not be regarded as limiting.

Reference in this application to “one embodiment,” “an embodiment,” “one or more embodiments,” or the like means that a particular feature, structure, or characteristic described in connection with the embodiment is included in at least one embodiment of the disclosure. The appearances of, for example, the phrases “an embodiment” in various places in the specification are not necessarily all referring to the same embodiment, nor are separate or alternative embodiments mutually exclusive of other embodiments. Moreover, various features are described which may be exhibited by some embodiments and not by the other. Similarly, various requirements are described which may be requirements for some embodiments but not by other embodiments.

### Device and Network Architecture

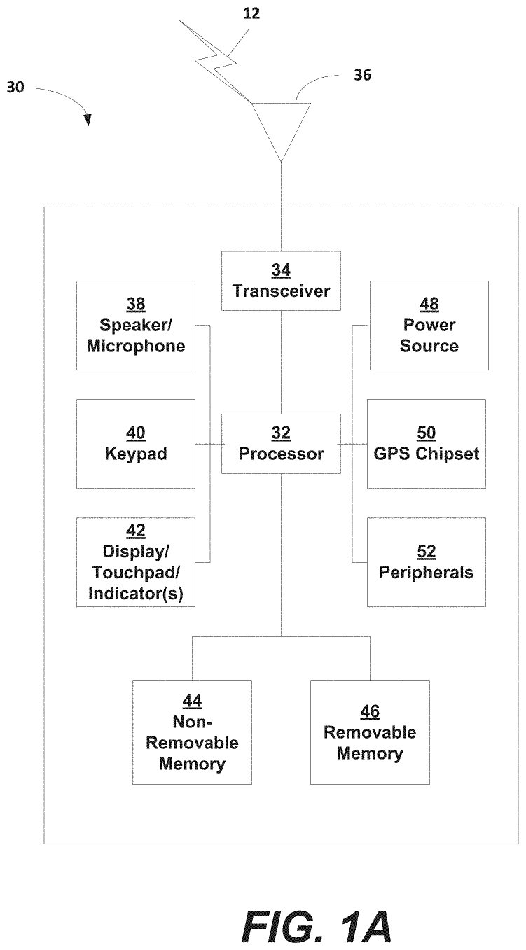

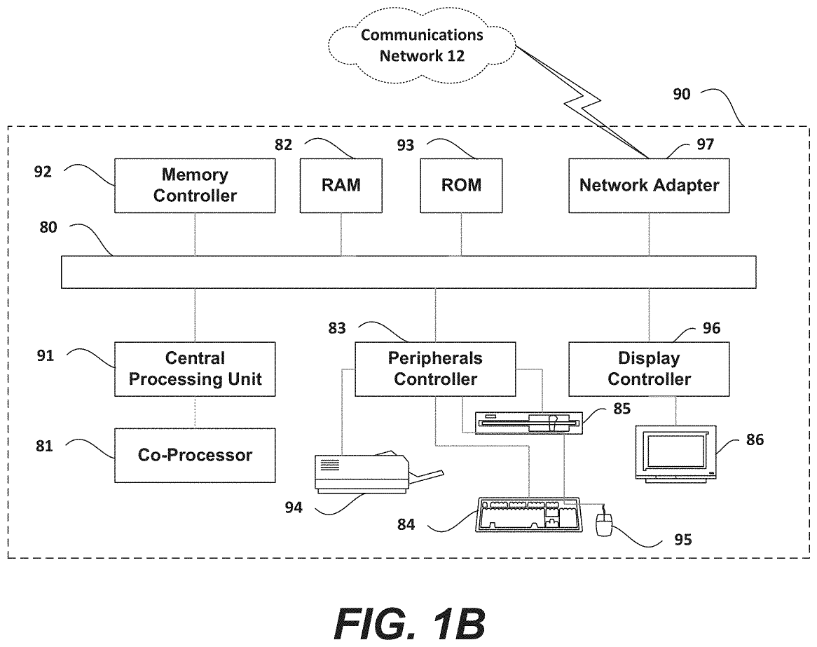

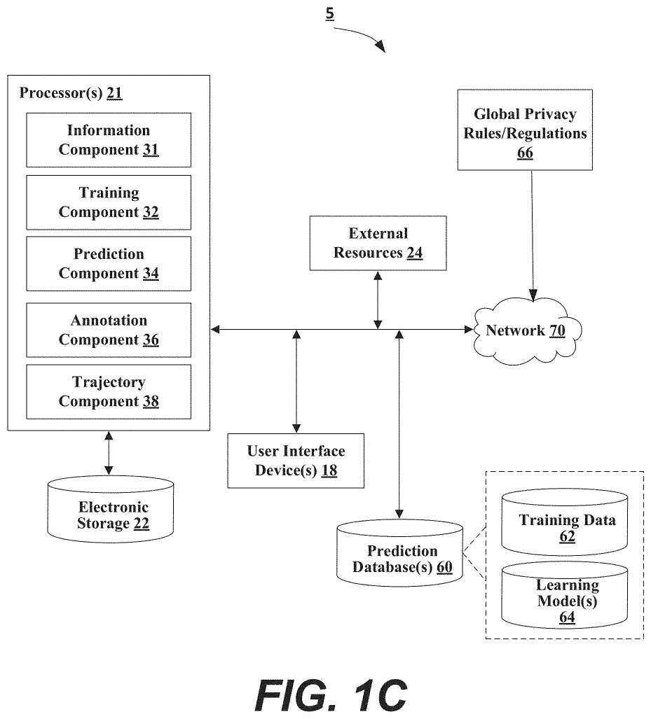

FIG. 1A is a block diagram of an exemplary hardware/software architecture of edge device 30 of a network which may operate as a server, gateway, device, or other edge device in a network. Edge device 30 may include processor 32, non-removable memory 44, removable memory 46, speaker/microphone 38, keypad 40, display, touchpad, and/or indicators 42, power source 48, global positioning system (GPS) chipset 50, and other peripherals 52. Edge device 30 may also include communication circuitry, such as transceiver 34 and transmit/receive element 36. Edge device 30 may include any sub-combination of the foregoing elements while remaining consistent with an embodiment.

Processor 32 may be a general purpose processor, a special purpose processor, a conventional processor, a digital signal processor (DSP), a plurality of microprocessors, one or more microprocessors in association with a DSP core, a controller, a microcontroller, application specific integrated circuits (ASICs), field programmable gate array (FPGAs) circuits, any other type of integrated circuit (IC), a state machine, and the like. In general, the processor 32 may execute computer-executable instructions stored in the memory (e.g., memory 44 and/or memory 46) of edge device 30 in order to perform the various required functions of edge device 30. For example, the processor 32 may perform signal coding, data processing, power control, input/output processing, and/or any other functionality that enables edge device 30 to operate in a wireless or wired environment. Processor 32 may run application-layer programs (e.g., browsers) and/or radio-access-layer (RAN) programs and/or other communications programs. The processor 32 may also perform security operations, such as authentication, security key agreement, and/or cryptographic operations. The security operations may be performed, for example, at the access layer and/or application layer.

As shown in FIG. 1A, processor 32 is coupled to its communication circuitry (e.g., transceiver 34 and transmit/receive element 36). Processor 32, through the execution of computer-executable instructions, may control the communication circuitry to cause edge device 30 to communicate with other edge devices via the network to which it is connected. While FIG. 1B depicts processor 32 and transceiver 34 as separate components, processor 32 and the transceiver 34 may be integrated together in an electronic package or chip.

Transmit/receive element 36 may be configured to transmit signals to, or receive signals from, other edge devices, including servers, gateways, wireless devices, and the like. For example, in an embodiment, transmit/receive element 36 may be an antenna configured to transmit and/or receive RF signals. The transmit/receive element 36 may support various networks and air interfaces, such as WLAN, WPAN, cellular, and the like. In an embodiment, the transmit/receive element 36 may be an emitter/detector configured to transmit and/or receive IR, UV, or visible light signals, for example. In yet another embodiment, transmit/receive element 36 may be configured to transmit and receive both RF and light signals. Transmit/receive element 36 may be configured to transmit and/or receive any combination of wireless or wired signals.

In addition, although the transmit/receive element 36 is depicted in FIG. 1A as a single element, edge device 30 may include any number of transmit/receive elements 36. More specifically, edge device 30 may employ multiple-input and multiple-output (MIMO) technology. Thus, in an embodiment, edge device 30 may include two or more transmit/receive elements 36 (e.g., multiple antennas) for transmitting and receiving wireless signals.

The transceiver 34 may be configured to modulate the signals to be transmitted by the transmit/receive element 36 and to demodulate the signals that are received by the transmit/receive element 36. As noted above, edge device 30 may have multi-mode capabilities. Thus, the transceiver 34 may include multiple transceivers for enabling edge device 30 to communicate via multiple RATs, such as Universal Terrestrial Radio Access (UTRA) and IEEE 802.11, for example.

The processor 32 may access information from, and store data in, any type of suitable memory, such as the non-removable memory 44 and/or the removable memory 46. For example, the processor 32 may store session context in its memory, as described above. The non-removable memory 44 may include random-access memory (RAM), read-only memory (ROM), a hard disk, or any other type of memory storage device. The removable memory 46 may include a subscriber identity module (SIM) card, a memory stick, a secure digital (SD) memory card, and the like. In other embodiments, the processor 32 may access information from, and store data in, memory that is not physically located on edge device 30, such as on a server or a home computer.

The processor 32 may receive power from the power source 48, and may be configured to distribute and/or control the power to the other components in edge device 30. The power source 48 may be any suitable device for powering edge device 30. For example, the power source 48 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 32 may also be coupled to the GPS chipset 50, which is configured to provide location information (e.g., longitude and latitude) regarding the current location of edge device 30. Edge device 30 may acquire location information by way of any suitable location-determination method while remaining consistent with an embodiment.

The processor 32 may further be coupled to other peripherals 52, which may include one or more software and/or hardware modules that provide additional features, functionality, and/or wired or wireless connectivity. For example, the peripherals 52 may include various sensors such as an accelerometer, an e-compass, a satellite transceiver, a sensor, a digital camera (for photographs or video), a universal serial bus (USB) port or other interconnect interfaces, a vibration device, a television transceiver, a hands free headset, a Bluetooth® module, a frequency modulated (FM) radio unit, an Internet browser, and the like.

As used herein, an edge or IoT device may be a user device, a consumer electronics device, a mobile phone, a smartphone, a personal data assistant, a digital tablet/pad computer, a wearable device (e.g., watch), augmented reality (AR) goggles, virtual reality (VR) goggles, a reflective display, a vehicle (e.g., embedded computer, such as in a dashboard or in front of a seated occupant of a car or plane), a game or entertainment system, a set-top-box, a monitor, a television (TV), a panel, a space craft, or any other device. In some embodiments, a processor of system 10 (e.g., in edge device 145 or another component communicably coupled thereto) may be configured to provide information processing capabilities. The processor may comprise one or more of a digital processor, an analog processor, a digital circuit designed to process information, an analog circuit designed to process information, a state machine, and/or other mechanisms for electronically processing information. In some embodiments, the processor may comprise a plurality of processing units. These processing units may be physically located within the same device (e.g., edge device 145), or the processor may represent processing functionality of a plurality of devices operating in coordination (e.g., one or more servers, user interface devices, devices that are part of external resources, electronic storage, and/or other devices).

Edge device 30 may also be embodied in other apparatuses or devices. Edge device 30 may connect to other components, modules, or systems of such apparatuses or devices via one or more interconnect interfaces, such as an interconnect interface that may comprise one of the peripherals 52.

FIG. 1B is a block diagram of an exemplary computing system 90 that may be used to implement one or more edge devices 30 of a network, and which may operate as a server, gateway, device, or other edge device in a network. In one embodiment, computing system 90 may operate as a local network manager controlling a group of devices. In another embodiment, computing system 90 may operate as a cloud host communicating with one or more local network managers.

The computing system 90 in FIG. 1B may comprise a computer or server and may be controlled primarily by computer-readable instructions, which may be in the form of software, by whatever means such software is stored or accessed. Such computer-readable instructions may be executed within a processor, such as a central processing unit (CPU) 91, to cause computing system 90 to effectuate various operations. In many known workstations, servers, and personal computers, the CPU 91 is implemented by a single-chip CPU called a microprocessor. In other machines, the CPU 91 may comprise multiple processors, including graphics processing units (GPUs). Co-processor 81 is an optional processor, distinct from CPU 91 that performs additional functions or assists the CPU 91.

In operation, CPU 91 fetches, decodes, executes instructions, and transfers information to and from other resources via the computer's main data-transfer path, system bus 80. Such system bus 80 connects the components in the computing system 90 and defines the medium for data exchange. System bus 80 typically includes data lines for sending data, address lines for sending addresses, and control lines for sending interrupts and for operating system bus 80. An example of such system bus 80 is the peripheral component interconnect (PCI) bus.

Memories coupled to system bus 80 include RAM 82 and ROM 93. Such memories include circuitry that allows information to be stored and retrieved. ROM 93 generally contains stored data that may not easily be modified. Data stored in RAM 82 may be read or changed by CPU 91 or other hardware devices. Access to RAM 82 and/or ROM 93 may be controlled by a memory controller 92. Memory controller 92 may provide an address translation function that translates virtual addresses into physical addresses as instructions are executed. Memory controller 92 may also provide a memory protection function that isolates processes within the system and isolates system processes from user processes. Thus, a program running in a first mode may access only memory mapped by its own process virtual address space. It may not access memory within another process's virtual address space unless memory sharing between the processes has been set up.

In addition, the computing system 90 may contain peripherals controller 83 responsible for communicating instructions from CPU 91 to peripherals, such as printer 94, keyboard 84, mouse 95, and disk drive 85.

Display 86, which is controlled by display controller 96, is used to display visual output generated by computing system 90. Such visual output may include text, graphics, animated graphics, and video. Display 86 may be implemented with a CRT-based video display, an LCD-based flat-panel display, gas plasma-based flat-panel display, or a touch-panel. Display controller 96 includes electronic components required to generate a video signal that is sent to display 86. The display 86 may include a GUI configured to portray the privacy settings and data obtained from each device 30. The GUI may also be configured to show the privacy settings and data obtained from one or more local networks.

### Artificial Neural Networks and Machine Learning

The terms artificial neural network (ANN) and neural network may be used interchangeably herein. An ANN may be configured to determine a classification (e.g., type of object) based on input image(s) or other sensed information. An ANN is a network or circuit of artificial neurons or nodes, and it may be used for predictive modeling.

The prediction models may be and/or include one or more neural networks (e.g., deep neural networks, artificial neural networks, or other neural networks), other machine learning models, or other prediction models.

Disclosed implementations of artificial neural networks may apply a weight and transform the input data by applying a function, this transformation being a neural layer. The function may be linear or, more preferably, a nonlinear activation function, such as a logistic sigmoid, Tan h, or ReLU function. Intermediate outputs of one layer may be used as the input into a next layer. The neural network through repeated transformations learns multiple layers that may be combined into a final layer that makes predictions. This learning (i.e., training) may be performed by varying weights or parameters to minimize the difference between the predictions and expected values. In some embodiments, information may be fed forward from one layer to the next. In these or other embodiments, the neural network may have memory or feedback loops that form, e.g., a neural network. Some embodiments may cause parameters to be adjusted, e.g., via back-propagation.

An ANN is characterized by features of its model, the features including an activation function, a loss or cost function, a learning algorithm, an optimization algorithm, and so forth. The structure of an ANN may be determined by a number of factors, including the number of hidden layers, the number of hidden nodes included in each hidden layer, input feature vectors, target feature vectors, and so forth. Hyperparameters may include various parameters which need to be initially set for learning, much like the initial values of model parameters. The model parameters may include various parameters sought to be determined through learning. And the hyperparameters are set before learning, and model parameters may be set through learning to specify the architecture of the ANN.

Learning rate and accuracy of an ANN rely not only on the structure and learning optimization algorithms of the ANN but also on the hyperparameters thereof. Therefore, in order to obtain a good learning model, it is important to choose a proper structure and learning algorithms for the ANN, but also to choose proper hyperparameters.

The hyperparameters may include initial values of weights and biases between nodes, mini-batch size, iteration number, learning rate, and so forth. Furthermore, the model parameters may include a weight between nodes, a bias between nodes, and so forth.

In general, the ANN is first trained by experimentally setting hyperparameters to various values, and based on the results of training, the hyperparameters may be set to optimal values that provide a stable learning rate and accuracy.

Some embodiments of models 64 in system 5 depicted in FIG. 1C may comprise a CNN. A CNN may comprise an input and an output layer, as well as multiple hidden layers. The hidden layers of a CNN typically comprise a series of convolutional layers that convolve with a multiplication or other dot product. The activation function is commonly a ReLU layer, and is subsequently followed by additional convolutions such as pooling layers, fully connected layers and normalization layers, referred to as hidden layers because their inputs and outputs are masked by the activation function and final convolution.

The CNN computes an output value by applying a specific function to the input values coming from the receptive field in the previous layer. The function that is applied to the input values is determined by a vector of weights and a bias (typically real numbers). Learning, in a neural network, progresses by making iterative adjustments to these biases and weights. The vector of weights and the bias are called screens or filters and represent particular features of the input (e.g., a particular shape).

In some embodiments, the learning of models 64 may be of reinforcement, supervised, semi-supervised, and/or unsupervised type. For example, there may be a model for certain predictions that is learned with one of these types but another model for other predictions may be learned with another of these types.

Supervised learning is the machine learning task of learning a function that maps an input to an output based on example input-output pairs. It may infer a function from labeled training data comprising a set of training examples. In supervised learning, each example is a pair consisting of an input object (typically a vector) and a desired output value (the supervisory signal). A supervised learning algorithm analyzes the training data and produces an inferred function, which may be used for mapping new examples. And the algorithm may correctly determine the class labels for unseen instances.

Unsupervised learning is a type of machine learning that looks for previously undetected patterns in a dataset with no pre-existing labels. In contrast to supervised learning that usually makes use of human-labeled data, unsupervised learning does not via principal component (e.g., to preprocess and reduce the dimensionality of high-dimensional datasets while preserving the original structure and relationships inherent to the original dataset) and cluster analysis (e.g., which identifies commonalities in the data and reacts based on the presence or absence of such commonalities in each new piece of data).

Semi-supervised learning makes use of supervised and unsupervised techniques.

Learning Models 64 may analyze made predictions against a reference set of data called the validation set. In some use cases, the reference outputs resulting from the assessment of made predictions against a validation set may be provided as an input to the prediction models, which the prediction model may utilize to determine whether its predictions are accurate, to determine the level of accuracy or completeness with respect to the validation set data, or to make other determinations. Such determinations may be utilized by the prediction models to improve the accuracy or completeness of their predictions. In another use case, accuracy or completeness indications with respect to the prediction models' predictions may be provided to the prediction model, which, in turn, may utilize the accuracy or completeness indications to improve the accuracy or completeness of its predictions with respect to input data. For example, a labeled training dataset may enable model improvement. That is, the training model may use a validation set of data to iterate over model parameters until the point where it arrives at a final set of parameters/weights to use in the model.

In some embodiments, training component 32 depicted in FIG. 1C may implement an algorithm for building and training one or more deep neural networks. A used model may follow this algorithm and already be trained on data. In some embodiments, training component 32 may train a deep learning model on collected training data 62 providing even more accuracy.

A model implementing a neural network may be trained using training data of storage/database 62. The training data may include many anatomical attributes. For example, this training data obtained from prediction database 60 of FIG. 1C may comprise hundreds, thousands, or even many millions of pieces of information (e.g., images, smays, or other sensed data) from the Internet, and more specifically, data suggestive of not meeting privacy laws and regulations of jurisdictions. For example, the laws may be based upon generally understood personally identifiable information (PII) types and/or information associated with protected classes, e.g., race, color, religion, national origin, ancestry, sex (e.g., gender, sexual orientation, and the like.

The system 5 may also obtain privacy rules 66 associated with one or more jurisdictions around the world. The privacy rules 66 may include for example, generally accepted practices for protecting PII and information of protected classes such as minors. The privacy rules 66 may directly be obtained from statutes and regulations of each relevant jurisdiction. The privacy rules 66 may be updated in real-time. The privacy rules 66 may also include judicially created law in view of decisions in various jurisdictions. The privacy rules may be used to develop and refine the learning models(s) 64. As the privacy rules 66 are updated, the learning model(s) 64 is further refined by the training component 32.

In some embodiments, training component 32 may be configured to obtain training data from any suitable source, e.g., via prediction database 60, electronic storage 22, external resources 24 (e.g., which may include sensors, smayners, or another device), network 70, and/or UI device(s) 18. The training data may comprise captured images, light/colors, shape sizes, noises or other sounds, and/or other discrete instances of sensed information.

In some embodiments, training component 32 may enable one or more prediction models to be trained. The training of the neural networks may be performed via several iterations. For each training iteration, a classification prediction (e.g., output of a layer) of the neural network(s) may be determined and compared to the corresponding, known classification. For example, sensed data known to capture a closed environment comprising dynamic and/or static objects may be input, during the training or validation, into the neural network to determine whether the prediction model may properly predict a path for the user to reach or avoid said objects. As such, the neural network is configured to receive at least a portion of the training data as an input feature space. Once trained, the model(s) may be stored in database/storage 64 of prediction database 60, as shown in FIG. 1C, and then used to classify samples of images or smays based on visible attributes.

Electronic storage 22 of FIG. 1C comprises electronic storage media that electronically stores information. The electronic storage media of electronic storage 22 may comprise system storage that is provided integrally (i.e., substantially non-removable) with system 5 and/or removable storage that is removably connectable to system 5 via, for example, a port (e.g., a USB port, a firewire port, etc.) or a drive (e.g., a disk drive, etc.). Electronic storage 22 may be (in whole or in part) a separate component within system 5, or electronic storage 22 may be provided (in whole or in part) integrally with one or more other components of system 5 (e.g., a user interface (UI) device 18, processor 21, etc.). In some embodiments, electronic storage 22 may be located in a server together with processor 21, in a server that is part of external resources 24, in UI devices 18, and/or in other locations. Electronic storage 22 may comprise a memory controller and one or more of optically readable storage media (e.g., optical disks, etc.), magnetically readable storage media (e.g., magnetic tape, magnetic hard drive, floppy drive, etc.), electrical charge-based storage media (e.g., EPROM, RAM, etc.), solid-state storage media (e.g., flash drive, etc.), and/or other electronically readable storage media. Electronic storage 22 may store software algorithms, information obtained and/or determined by processor 21, information received via UI devices 18 and/or other external computing systems, information received from external resources 24, and/or other information that enables system 5 to function as described herein.

External resources 24 may include sources of information (e.g., databases, websites, etc.), external entities participating with system 5, one or more servers outside of system 5, a network, electronic storage, equipment related to Wi-Fi technology, equipment related to Bluetooth® technology, data entry devices, a power supply (e.g., battery powered or line-power connected, such as directly to 110 volts AC or indirectly via AC/DC conversion), a transmit/receive element (e.g., an antenna configured to transmit and/or receive wireless signals), a network interface controller (NIC), a display controller, a graphics processing unit (GPU), and/or other resources. In some implementations, some or all of the functionality attributed herein to external resources 24 may be provided by other components or resources included in system 5. Processor 21, external resources 24, UI device 18, electronic storage 22, a network, and/or other components of system 5 may be configured to communicate with each other via wired and/or wireless connections, such as a network (e.g., a local area network (LAN), the Internet, a wide area network (WAN), a radio access network (RAN), a public switched telephone network (PSTN), etc.), cellular technology (e.g., GSM, UMTS, LTE, 5G, etc.), Wi-Fi technology, another wireless communications link (e.g., radio frequency (RF), microwave, infrared (IR), ultraviolet (UV), visible light, cm wave, mm wave, etc.), a base station, and/or other resources.

User interface (UI) device(s) 18 of system 5 may be configured to provide an interface between one or more users and system 5. UI devices 18 are configured to provide information to and/or receive information from the one or more users. UI devices 18 include a UI and/or other components. The UI may be and/or include a UI configured to present views and/or fields configured to receive entry and/or selection with respect to particular functionality of system 5, and/or provide and/or receive other information. In some embodiments, the UI of UI devices 18 may include a plurality of separate interfaces associated with processors 21 and/or other components of system 5. Examples of interface devices suitable for inclusion in UI device 18 include a touch screen, a keypad, touch sensitive and/or physical buttons, switches, a keyboard, knobs, levers, a display, speakers, a microphone, an indicator light, an audible alarm, a printer, and/or other interface devices. The present disclosure also contemplates that UI devices 18 include a removable storage interface. In this example, information may be loaded into UI devices 18 from removable storage (e.g., a smart card, a flash drive, a removable disk) that enables users to customize the implementation of UI devices 18.

In some embodiments, UI devices 18 are configured to provide a UI, processing capabilities, databases, and/or electronic storage to system 5. As such, UI devices 18 may include processors 21, electronic storage 22, external resources 24, and/or other components of system 5. In some embodiments, UI devices 18 are connected to a network (e.g., the Internet). In some embodiments, UI devices 18 do not include processor 21, electronic storage 22, external resources 24, and/or other components of system 5, but instead communicate with these components via dedicated lines, a bus, a switch, network, or other communication means. The communication may be wireless or wired. In some embodiments, UI devices 18 are laptops, desktop computers, smartphones, tablet computers, and/or other UI devices.

Data and content may be exchanged between the various components of the system 5 through a communication interface and communication paths using any one of a number of communications protocols. In one example, data may be exchanged employing a protocol used for communicating data across a packet-switched internetwork using, for example, the Internet Protocol Suite, also referred to as TCP/IP. The data and content may be delivered using datagrams (or packets) from the source host to the destination host solely based on their addresses. For this purpose the Internet Protocol (IP) defines addressing methods and structures for datagram encapsulation. Of course other protocols also may be used. Examples of an Internet protocol include Internet Protocol version 4 (IPv4) and Internet Protocol version 6 (IPv6).

As shown in FIG. 1C, processor 21 is configured via machine-readable instructions to execute one or more computer program components. The computer program components may comprise one or more of information component 31, training component 32, prediction component 34, annotation component 36, trajectory component 38, and/or other components. Processor 21 may be configured to execute components 31, 32, 34, 36, and/or 38 by: software; hardware; firmware; some combination of software, hardware, and/or firmware; and/or other mechanisms for configuring processing capabilities on processor 21.

It should be appreciated that although components 31, 32, 34, 36, and 38 are illustrated in FIG. 1C as being co-located within a single processing unit, in embodiments in which processor 21 comprises multiple processing units, one or more of components 31, 32, 34, 36, and/or 38 may be located remotely from the other components. For example, in some embodiments, each of processor components 31, 32, 34, 36, and 38 may comprise a separate and distinct set of processors. The description of the functionality provided by the different components 31, 32, 34, 36, and/or 38 described below is for illustrative purposes, and is not intended to be limiting, as any of components 31, 32, 34, 36, and/or 38 may provide more or less functionality than is described. For example, one or more of components 31, 32, 34, 36, and/or 38 may be eliminated, and some or all of its functionality may be provided by other components 31, 32, 34, 36, and/or 38. As another example, processor 21 may be configured to execute one or more additional components that may perform some or all of the functionality attributed below to one of components 31, 32, 34, 36, and/or 38.

### Content Sharing Architecture

According to one aspect of the present application, an architecture is described that allows a local network administrator to control the type, content and amount of filtered data received from edge devices that may be shared with one or more third parties. The architecture may also be configured for a cloud host to control the type, content and amount of filtered data received from one or more local network administrators. The filtered data may selectively be shared with one or more third parties.

The content and amount of filtered data for a particular type of data may depend upon credentials of the third party. Credentials may include a status of a data sharing agreement between the third party on one end and the local network and/or cloud host on the other. The credentials may also include a security clearance of the third party, terms of use for the transmitted data for a particular purpose, downstream selling/license restrictions, or the like. The content and amount for a particular type of data may also depend upon the More particularly, a data owner or licensee is able to control how data and data derivates are delivered downstream to one or more third party customers.

In one or more embodiments, different attributes associated with data may be removed from data prior to sharing with a local network and/or cloud host in view of a trained machine learning algorithm. Alternatively, different attributes associated with data may be removed prior to sharing with a third party. For example, the removed attribute may not meet a predetermined privacy threshold of the edge device, local network, cloud host and/or a third party. As discussed above, the privacy threshold may be configured in view of real-time changes in privacy rules, e.g., laws, statutes, court decisions, in various jurisdictions around the world. The privacy threshold may be customized in view of the location where data is transmitted and required to reside.

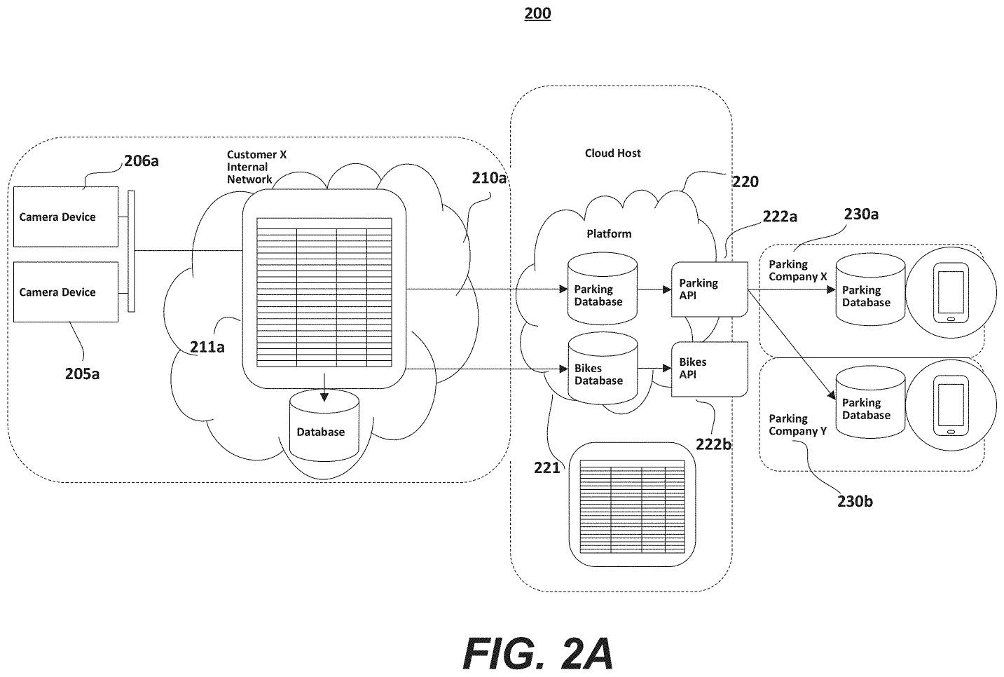

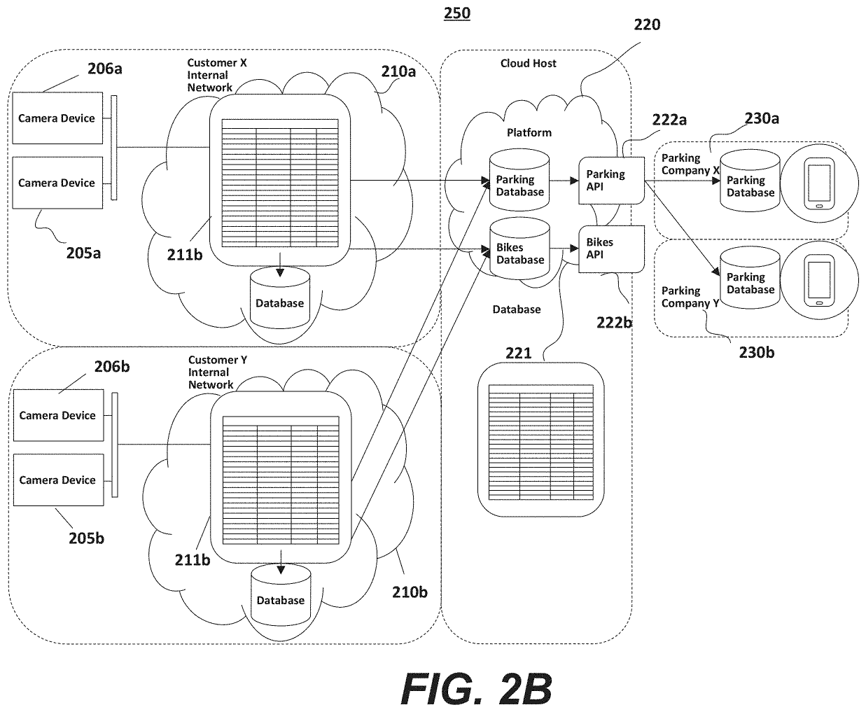

FIG. 2A illustrates an exemplary system architecture 200 of the instant application. According to an embodiment of this aspect, architecture 200 may include cloud or hybrid cloud environments. More particularly, the technology may include programmable APIs customized to filter one or more types of data. Post-filtering, the data may be transmitted downstream to third party customers.

Beginning with the left side of system 200, one or more IoT devices 205a, 206a each including one or more sensors are located in an operating environment. The operating environment, for example, may include an entire city, portions thereof, landmarks and/or locations where people, items, or IoT devices congregate.

A device ID may be associated with the IoT device. Specifically, the device ID has a separate level of metadata and describes who owns or operates the device, its location, the direction it faces, etc. If the IoT device has plural sensors, it is envisaged that each sensor may share a similar device ID for tracking purposes. Alternatively, each sensor may have a separate sub device ID to help further parse data. This allows auditability of downstream consumed data. As a result, a data governance system which creates ACLs based on metadata and streams of data may be possible.

In one or more embodiments the LAN could be a WAN depending upon the size of the network. There may be one or more LANs/WANs in the system architecture 200. The local network may be associated with an entity. For example, local network 210a may be an entity associated with a local network administrator or customer, e.g., Customer X. Local network 210a may be public or private.

FIG. 2B illustrates another exemplary system architecture 250 of the instant application according to an aspect. FIG. 2B may be similar to FIG. 2A yet includes an additional local network 210b including its own IoT devices, e.g., cameras with sensors, 205b, 206b. The local network 210b may be associated with an entity such as a network administrator or customer, e.g., Customer Y. The local networks 210a, 210b may be public and/or private.

In reference to FIGS. 2A and/or 2B, data may be obtained from the environment via plural IoT devices, such as for example cameras or other sensing devices, communicating over the network 210a, 210b. The data may be filtered at the IoT device employing one or more trained machine learning algorithms seeking to minimize privacy concerns set by rules in various jurisdictions. The filtered data may be transmitted to the local network 210a, 210b.

According to an embodiment, each of networks 210a, 210b may employ a trained machine learning algorithm to further filter data received from the plural IoT devices to minimize privacy concerns in view of local or external preferences including but not limited to privacy rules set by one or more jurisdictions. This may be exemplary illustrated as a privacy filter 211a, 211b in each of respective networks 210a and 210b. In addition to filtering, the privacy filter may also be configured to anonymize data aggregated from its plural IoT devices. Doing one or both of filtering and anonymizing may aide in minimizing privacy issues upon collected data being transmitted to one or more downstream entities, such as for example, a cloud host 220 or third party data consumer.

In FIG. 2A, a cloud host 220 is shown being in communication with Customer X's network 210a. In FIG. 2B, cloud host 220 is shown being in communication with both Customer X's network 210a and Customer Y's network 210b. In both FIGS. 2A and 2B, cloud host 220 may operate a platform that includes one or more databases housing data for respective detected objects in the environment. The detected object in the environment may include one or more of a vehicle, person, animal, smart object and inanimate object. Namely, FIG. 2B illustrates filtered data housed in each of the local networks' databases 211a, 211b, being transmitted to cloud host 200's databases. For example, similar types of data, such as for example parking data or bike data from local networks, may respectively be aggregated and stored in parking and bike databases at cloud host 220.

According to an embodiment, cloud host 220 may employ a trained machine learning algorithm to further filter data received from each of networks 210a, 210b to minimize privacy concerns. This is illustrated as the privacy filter 221. In addition to filtering, the privacy filter 221 may also be configured to anonymize data aggregated from each local network 210a, 210b. Doing one or both of filtering and anonymizing may aide in minimizing privacy issues upon collected data being transmitted to a third party data consumer, such as for example 230a, 230b.

According to an embodiment, a third party data consumer may be interested in vehicular parking information. The third party data consumer may benefit from culled data obtained from plural local networks within a specific geographic location to forecast a trend ultimately to monetize upon this obtained information. Data may be further restricted based on specific subcategories of vehicles, e.g., 2-wheel versus 4-wheel vehicles.

In another embodiment, information may include particular demographics utilizing parking garages. Privacy filters may be employed when demographics includes minors or other protected classes. In so doing, the data consumer may use the information to employ marketing and advertising campaigns directly targeting specific end users to increase sales and revenue.

Alternatively, the third party data consumer may use the received data as a source to run one or more downstream applications operating on a display of user equipment. For example, parking data may be used by an application developer to help other drivers locate available spots in one or more garages over a specific area. In another example, parking data may be used to help police departments enforce ticketing violations.

In yet another embodiment, the third party data consumer may be a waste management company. The data may assist the waste management company to route collection vehicles to areas exhibiting the most demand. Specifically, image data collected from plural cameras over plural local networks may be aggregated to identify locations where trash receptacles are full.

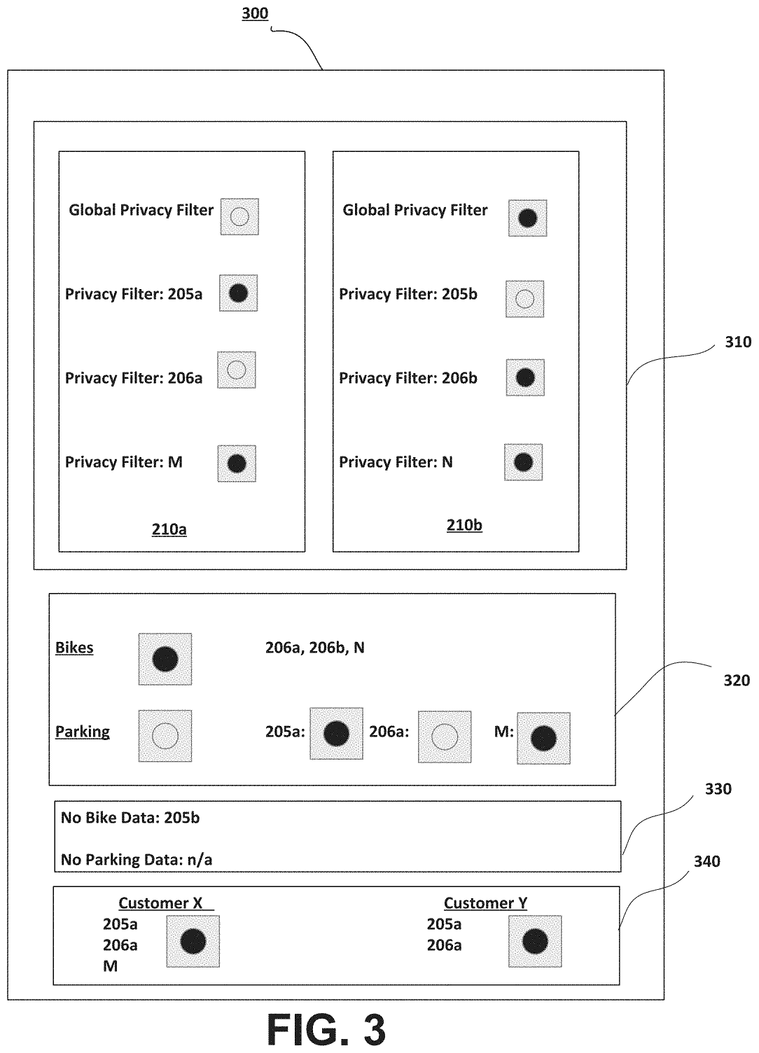

Reference will now be made to FIG. 3 illustrating a GUI 300 of the cloud host 220. More specifically, view 310 may depict a macro view of only local network privacy filter states. Alternatively, a detailed schematic of local network and IoT device privacy filter states may be depicted as shown in FIG. 3 either on the primary GUI or a subsequent GUI based on one or more prompts. The state of each filter may be static, periodically changing at a predetermined interval or changing in real-time. As particularly shown in FIG. 3 for example, local network 210a may not have a global privacy filter enabled on data collected from its IoT devices 205a, 206a, and M. In other words, the local network 210a from its IoT devices is not subsequently filtered according to this embodiment. Data received from IoT devices 205a and M arrives in a filtered state, while data received from IoT device 206a arrives in a unfiltered state. Data may opt to remain unfiltered for one of many reasons. One reason may be when privacy concerns are not raised and safe to transmit to another entity. Another reason may be when the trained machine learning algorithm determines the unfiltered data is appropriate for transmission to the local network.

Still, according to this embodiment, view 310 depicts local network 210b including a global privacy filter. This means any data, whether previously filtered or unfiltered by IoT devices, requires filtering. Here, while IoT device 205b did not require filtering, each of IoT devices 206b and N required filtering.

According to another embodiment in reference to FIG. 3, cloud host 220 may include a view 320 depicting whether specific content includes a filter at either the IoT device or local network level. As depicted in view 320, data on bikes is all filtered. This is important in instances when the cloud host 220 wishes to tag data transmitted downstream to a customer to see how the data is used. On the other hand, data on Parking is not all filtered. Here, IoT device 206a is shown not being filtered at the device level as well as the local network level. IoT devices 205a and M are shown being filtered at either the device or local network level. It is envisaged according to the instant application that a subsequent view may allow the cloud host to check whether data is filtered one or plural times via a separate icon, e.g., half-shaded circle.

According to even another embodiment in connection with FIG. 3, a view 330 may provide information as to any IoT devices failing to provide data of specific content. As shown, IoT device 205b does not provide bike data. On the other hand, all devices appear to share information associated with parking data.

According to an embodiment of the privacy filter, Table 1 shown below provides an exemplary filter sequence at cloud host 220. The filter sequence may appear as a GUI on a display either locally at cloud host 220 or on another server. Starting from the left of Table 1, the first column lists a Workspace. Workspaces may also be known as regions or selected areas from which IoT devices collect data. As shown below, the workspaces are the same, e.g., City of Denver, for rows 1-3. In other embodiments, the workspaces may be different. For instance, the workspace for rows 1 and 2 may be the City of Denver and the workspace for row 3 may be the city of Austin.

TABLE 1

| | Approved | | | | | | Max |
|---|---|---|---|---|---|---|---|
| | API | Sensor | Object | Platform | | Frequency | Inquiries |
| Workspace | Customer | Type | Type | API Name | Geofence | Allowance | per Day |
| City of | ABC | Position | Vehicle | City | None | 1 Second | 1,000,000 |
| Denver | Parking | Occupancy | | Parking | | | |
| | Company, | | | Data | | | |
| | Smartcars | | | | | | |
| City of | XYZ | ALPR | Vehicle | Private | None | 1 Min | 1000 |
| Denver | Parking | Count | | Parking | | | |
| | Company, | | | Data | | | |
| | Smartcars | | | | | | |
| City of | CDRE | Counts | Pedestrian | Ped Counts | Geofence_1 | 1 Week | 100 |
| Denver | | | | | | | |

The second column of Table 1 lists one or more Approved API Customers. For instance, the approved API customer found on row 1 is ABC Parking company. Meanwhile, the approved API customer found on row 2 is XYZ parking company. The fifth column of Table 1 provides an identification of the originated data, e.g., Platform API Name. For example, data transmitted to ABC Parking Company may originate from city parking data and thus be identified as such. Meanwhile data transmitted to XYZ Parking Company may originate from private parking data and be similarly identified as such.

As further described in Table 1, the filter may include a Sensor Type as shown in the third column of Table 1. The sensor may detect position of an object or person, occupancy in an designated area, visual information such as license plate information, or features of people entering/leaving an environment. Regarding people, the data may be based on demographics. That is, the data may be filtered by height, weight, sex and any other distinguishing characteristics. The data may be filtered one or plural time in view of privacy rules in specific jurisdictions where the information is collected, stored, transmitted and used.

Another filter may include an Object Type as shown in the fourth column of Table 1. The Object Type may be a pedestrian, animal, vehicle or static object.

Yet another filter may include Geofencing Style as shown in column 6 of Table 1. Geofencing Style generally includes a specific area within the environment that is monitored. The geofencing style may be turned off or on with varying levels of sensitivity. For instance, a space-filling curve for key/index of the data may be employed. This allows efficient data storage near its closest neighbors and allows geo-fencing at scale.

Further, the filter may include Frequency and Max Inquiries Per Day as shown in columns 7 and 8 of Table 1. The Frequency may be as short as 1 second and as long as 1 week. The Max Inquiries Per Day may range anywhere from as little as 1 inquiry to a maximum of 1,000,000, or even higher. Controlling the maximum number of inquiries helps conserve battery life of the IoT sensors. Additionally, controlling daily inquiries help manage data collected and stored on a server.

Referring again to the GUI 300 of cloud host 220 depicted in FIG. 3, a dynamic representation of the cloud host's third party customers interested in obtaining data may be displayed. More specifically, the GUI 300 may dynamically display which third party customers are receiving filtered data. As shown in view 340, Customer X, e.g. a parking garage company, obtains filtered parking data originating from all smart devices having parking data shown in view 320. These smart devices include 205a, 206a and M. The frequency and duration of data received, as well as any supplemental privacy settings beyond what is has been established by the smart device, may selectively be initiated and updated by the cloud host 220 based upon the credentials of the third party customer. The privacy setting may avoid data associated with protected classes or that raise privacy issues under local, national or international laws or generally accepted practices.

Customer Y shown in View 340 may also be a parking garage company. Customer Y may obtain filtered parking data originating from smart devices 205a and 206a. However Customer Y does not receive parking data from smart device M. This may be attributed to Customer Y's credentials failing to meet a minimum threshold requirement of privacy associated with M's data.

In an alternative embodiment, cloud host 220 may check its customer's credentials again at a later time (e.g., month, week or annual review). Credentials may alternatively be automatically checked in real-time. If the minimum threshold privacy requirement is subsequently met based on the supplemental check, the customer may then begin receiving previously withhold data. This may be the case for Customer Y as described in the preceding paragraph.

In even a further embodiment, the cloud host may control the content and speed of providing data to a third party. Moreover, the data type may include pictures and/or metadata. If the data is visual, data may be controlled to comply with personally identifiable information (PII) privacy controls. For example, the visual data may include a picture full frame, a bounding box, or full frame video. Further, the type of metadata fields delivered may include positional, speed, occupancy and count.

In one embodiment, the data may be further anonymized if needed to remove any identifiers of the source data. Alternatively, each smart device may include a unique identifier. The tag or code is retained with specific data as it is transmitted to LAN(s), cloud hosts, and data seeking customers. The tag or code provides an auditing mechanism for consumed data. In a further embodiment, the tag may include UUID hashes. The UUID hashes include a recoverable query listing attributes including device(s), geofence, data type, model, etc. used to generate the data. This data may be stored in a blockchain. The blockchain provides a trustless audit trail of which devices, when, where and how the data was originated.

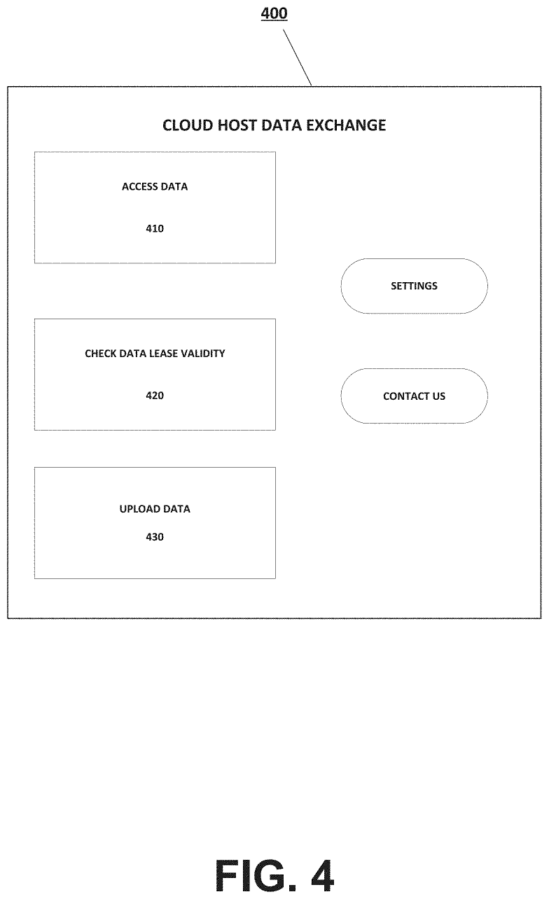

According to even another aspect of this application, a data owner such as a local network 210 or cloud host 220 may require each third party customer to sign into a system to access data. The data consumer may need to input a username/credential. This may help monitor downstream usage of data. An exemplary embodiment of this aspect is depicted in FIG. 4 as GUI 400. The third party data customer may have the option to access data from the cloud host via prompt 410. The third party customer may also have the option to check the validity of its data sharing agreement with a cloud host at prompt 420. A process of the cloud host may query a data catalog for a hashed value associated with the data lease. In an embodiment, the hashed value represents the sensor in the environment obtaining information of an object. In an embodiment, prompt 420 may also permit renegotiating a data sharing agreement with the consumer, where the new lease is based on terms including price, frequency, and amount of the data. The data consumer may also have the option to upload data to help better train the machine learning model of the cloud host via prompt 430.

The additional filtering may include includes location, sensor type, object type, geofencing, frequency and counts. The object type incudes one or more of a vehicle, pedestrian, and product. The additional filtering includes an identifier code. The additional filter may also include demographic information.

### Uses Cases

In one use case according to an exemplary embodiment, a nationwide grocery chain employs specific cameras to monitor operational efficiency at their local stores. Each of the camera's sensors may detect various objects based on preset filters. For example, the sensors may detect how many patrons are entering the store, location of each patron within the store, and demographic-specific data.

The data gained from these filters may be monetized. Namely, the data may be sold to entities in related fields of commerce. For example, a cereal manufacturer would benefits from understanding and obtaining the data via an API call. The API calls could be related to one or more aspect such as demographics, dwell time, frequency in the store aisle purchasing their products.

Each grocery store or even an entire grocery chain may customize filters to have specific policy controls. For instance, the policy controls may restrict internal access to select groups or persons for privacy reasons. The policy controls may also restrict external access to one or more third parties.

In another use case, Smart City A may employ smart cameras and a variety of IoT sensors to perform one or more tasks such as automating signaling for multimodal traffic. The task may also include informing operations teams of events, e.g., collisions, slowdowns, crowds, etc. The task may further include furnishing planning teams with data to back capital decisions, e.g., traffic data, speeds, reports, etc. Based upon the sensor's tasks, Smart City A may generate a vast amount of hyperlocal, real-time data.

Smart City A may partner with value added data resellers operating in the cloud. The information obtained by cloud providers or data resellers may be collected, aggregated and manage from plural sources. The data may be further filtered for security or privacy reasons, or alternatively randomized, prior to delivering to a third party. The delivered data is customizable. That is, the supplied data may be historical or real-time data.

Data generated by Smart City A's IoT devices may ultimately be sold to a parking company to evaluate volume and/or competition. The generated data may also be sold to a waste management company to determine where waste is most abundant in various jurisdictions to most effectively disseminate its fleet. The information may also be sold to app developers looking to directly provide a service to members of the community, e.g., locating a metered spot in the city. The data can be provided as a one-time offering, or alternatively, as a paid subscription.

In one aspect of this use case, Smart City A may have a more conservative privacy policy than its peers for disseminating collected data. Smart City A may elect to withhold public or group access to a particular data channel, such as for example, bike information or parking garage information. Smart City A may also elect to withhold data from a particular group, such as a company, person or protected class such as minors.

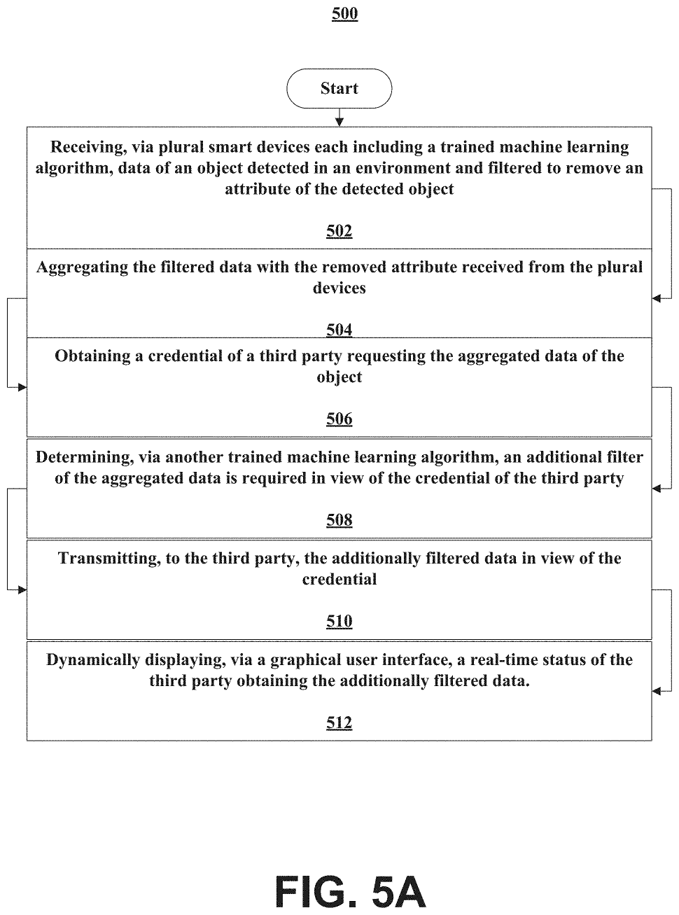

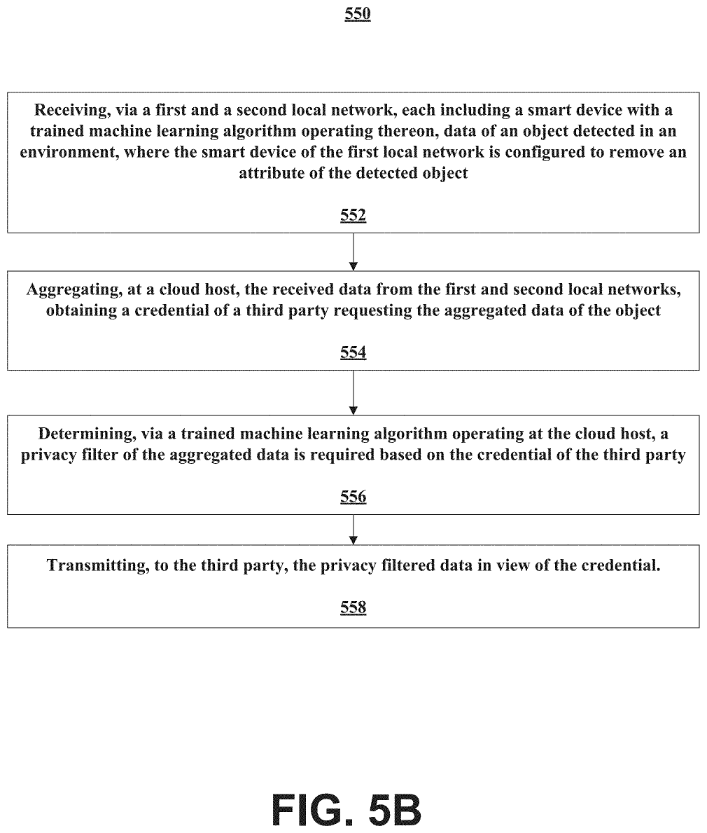

According to another aspect of the application, a system 500 is depicted in FIG. 5A and describes one or more computers configured to perform particular operations or actions by virtue of having software, firmware, hardware, or a combination of them installed on the system that in operation causes the system to perform actions. One or more computer programs on a non-transitory computer readable medium may also be configured to perform particular operations or actions by virtue of instructions that, when executed by data processing apparatus, cause the apparatus to perform the actions.

In an embodiment of this aspect, steps or instructions executable by a processor may include receiving, via plural smart devices each including a trained machine learning algorithm, data of an object detected in an environment. The data may be filtered to remove an attribute of the detected object (502). Another step or instruction may include aggregating the filtered data with the removed attribute received from the plural devices (504). Yet another step or instruction may include obtaining a credential of a third party requesting the aggregated data of the object (506). Yet even another step or instruction may include determining, via another trained machine learning algorithm, an additional filter of the aggregated data is required in view of the credential of the third party (508). A further step or instruction may include transmitting, to the third party, the additionally filtered data in view of the credential (510). Yet a further step or instruction may include dynamically displaying, via a GUI, a real-time status of the third party obtaining the additionally filtered data (512). This may entail an amount of filtered content shared, the frequency at which it is being shared, and/or high/low periods of transmission due to the IoT device being in an inactive state, or instances where no data has been generated from the environment.

According to an embodiment of this or other aspects, the third party referenced in the application may include plural third parties requesting the aggregated data. Additionally, the GUI may dynamically display a real-time status of the plural third parties obtaining the additionally filtered data.

According to another embodiment of this or other aspects, another step or instruction executable by a processor may include dynamically displaying, via the GUI, a change in the real-time status of the third party receiving the additionally filtered data. The change may be based upon an updated privacy setting or an updated credential.

According to even another embodiment of this or other aspects, another step or instruction executable by a processor may include dynamically displaying, via the GUI, a real-time status of the filters of the plural smart devices, and at least one the plural smart devices from which the additionally filtered data originated.

According to another embodiment of this or other aspects, another step or instruction executable by a processor may include modifying, based on the determination and via the other trained machine learning algorithm, the attribute or a second attribute of the aggregated filtered data falling below a minimum privacy threshold set for the third party.

According to another embodiment of this or other aspects, another step or instruction executable by a processor may include coding the plural smart devices with an identifier. Subsequently, history of the data may be analyzed in view of the coding. This may be performed after transmission of the filtered data to the third party.

According to even another aspect of the application, a system 550 as depicted in FIG. 5B describes one or more computers configured to perform particular operations or actions by virtue of having software, firmware, hardware, or a combination of them installed on the system that in operation causes or cause the system to perform the actions. One or more computer programs may be configured to perform particular operations or actions by virtue of including instructions that, when executed by data processing apparatus, cause the apparatus to perform the actions.

One embodiment of this aspect, steps or instructions executable by a processor may include receiving, via a first and a second local network, each including a smart device with a trained machine learning algorithm operating thereon, data of an object detected in an environment (552). The smart device of the first local network may be configured to remove an attribute of the detected object. Another step or instruction may include Aggregating, at a cloud host, the received data from the first and second local network (554). Yet another step or instruction may include determining, via a trained machine learning algorithm operating at the cloud host, a privacy filter of the aggregated data is required based on the credential of the third party (556). A further step or instruction may include transmitting, to the third party, the privacy filtered data in view of the credential (558).

In an embodiment of this or other aspects, another step or instruction executable by a processor may include dynamically displaying, via a GUI, a real-time status of active filters for one or more of the smart devices, and a real-time status of the third party receiving privacy filtered data.

In an embodiment of this or other aspects, another step or instruction executable by a processor may include dynamically displaying via the GUI at least one of the plural smart devices from which the privacy filtered data originated.

In another embodiment of this or other aspects, another step or instruction executable by a processor may include dynamically displaying via a GUI a change in the real-time status of the third party receiving the privacy filtered data. The change may be based upon an updated privacy setting of the cloud host or an updated credential of the third party.

In even an embodiment of this or other aspects, the third party may include plural third parties requesting the aggregated data. Additionally, the GUI may be configured to dynamically display a real-time status of the plural third parties obtaining the privacy filtered data.

In a further embodiment of this or other aspects, another step or instruction executable by a processor may include modifying, based on the determination and via the trained machine learning algorithm operating at the cloud host, the attribute or a second attribute of the privacy filtered data falling below a minimum privacy threshold set for the third party.

While the system and method have been described in terms of what are presently considered to be specific embodiments, the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

What is claimed is:

1. A method comprising:
receiving, via plural smart devices each including a trained machine learning algorithm, data of an object detected in an environment and filtered to remove an attribute of the detected object;
aggregating the filtered data with the removed attribute received from the plural devices;
obtaining a credential of a third party requesting the aggregated data of the object;
determining, via another trained machine learning algorithm, an additional filter of the aggregated data is required in view of the credential of the third party;
transmitting, to the third party, the additionally filtered data in view of the credential; and
dynamically displaying, via a graphical user interface, a real-time status of the third party obtaining the additionally filtered data.

2. The method of claim 1, wherein the third party includes plural third parties requesting the aggregated data, and the graphical user interface dynamically displays a real-time status of the plural third parties obtaining the additionally filtered data.

3. The method of claim 1, further comprising:
dynamically displaying, via the graphical user interface, a change in the real-time status of the third party receiving the additionally filtered data based upon an updated privacy setting or an updated credential.

4. The method of claim 1, further comprising:
dynamically displaying, via the graphical user interface, a real-time status of the filters of the plural smart devices, and at least one the plural smart devices from which the additionally filtered data originated.

5. The method of claim 1, further comprising:
modifying, based on the determination and via the other trained machine learning algorithm, the attribute or a second attribute of the aggregated filtered data falling below a minimum privacy threshold set for the third party.

6. The method of claim 1, further comprising:
anonymizing the aggregated data to remove identifiers of the plural smart devices.

7. The method of claim 1, wherein
the filter is based on a location, sensor type, geofencing, frequency and count, and
the additional filter is based on demographic information.

8. The method of claim 1, wherein the detected object in the environment includes one or more of a vehicle, person, animal, smart object and inanimate object.

9. The method of claim 1, wherein a cloud host performs the obtaining, determining and transmitting steps.

10. The method of claim 1, further comprising:
coding the plural smart devices with an identifier; and
analyzing a history of the data in view of coding after the transmission to the third party.

11. The method of claim 1, wherein the credential includes a status of a data sharing agreement.

12. A method comprising:
receiving, via a first and a second local network, each including a smart device with a trained machine learning algorithm operating thereon, data of an object detected in an environment, where the smart device of the first local network is configured to remove an attribute of the detected object;
aggregating, at a cloud host, the received data from the first and second local networks,
obtaining a credential of a third party requesting the aggregated data of the object;
determining, via a trained machine learning algorithm operating at the cloud host, a privacy filter of the aggregated data is required based on the credential of the third party; and
transmitting, to the third party, the privacy filtered data in view of the credential.

13. The method of claim 12, further comprising:
dynamically displaying, via a graphical user interface, a real-time status of active filters for one or more of the smart devices, and a real-time status of the third party receiving privacy filtered data.

14. The method of claim 12, wherein the graphical user interface dynamically displays at least one of the plural smart devices from which the privacy filtered data originated.

15. The method of claim 12, further comprising:
dynamically displaying, via the graphical user interface, a change in the real-time status of the third party receiving the privacy filtered data, wherein the change is based upon an updated privacy setting of the cloud host or an updated credential of the third party.

16. The method of claim 12, wherein the third party includes plural third parties requesting the aggregated data, and the graphical user interface dynamically displays a real-time status of the plural third parties obtaining the privacy filtered data.

17. The method of claim 12, further comprising:
modifying, based on the determination and via the trained machine learning algorithm operating at the cloud host, the attribute or a second attribute of the privacy filtered data falling below a minimum privacy threshold set for the third party.

18. The method of claim 12, wherein the filter is based on location, sensor type, geofencing, frequency and count, and the privacy filtered data is based on demographic information.

19. The method of claim 12, wherein the detected object in the environment includes one or more of a vehicle, person, animal, smart object and inanimate object.

20. The method of claim 12, wherein the credential includes a status of a data sharing agreement.
